(19) United States
(12) Patent Application Publication
(10) Pub. No.: US 2003/0232615 A1
(43) Pub. Date: Dec. 18, 2003

(54) Billing System and method for wireless internet system

(76) Inventors: Se-Han Kim, Seoul (KR); Hyun-Woo Lee, Daejeon (KR); Won Ryu, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/453,198

(22) Filed: Jun. 3, 2003

(30) Foreign Application Priority Data
Jun. 12, 2002 (KR) 2002-77330

(51) Int. Cl. H04K 3/00; H04M 11/00

(52) U.S. Cl. 455/405; 455/406; 455/422.1; 455/445

(57) ABSTRACT

A billing method and system connected to a wireless access point for wireless network access for charging for a service provided to a user terminal connected to the network. The wireless access point connects the user terminal to a wireless network. The wireless access point uses a hardware address of an access-authenticated user terminal to measure a data packet usage amount transmitted to the user terminal. The system bills each user according to the packet usage amount based on the data packet usage amount measured by the wireless access point.

### CROSS REFERENCE TO RELATED APPLICATION

This application is based on Korea Patent Application No. 2002-77330 filed on Dec. 6, 2002 in the Korean Intellectual Property Office, the content of which is incorporated herein by reference.

### BACKGROUND OF THE INVENTION

(a) Field of the Invention

The present invention relates to a WLAN (wireless local area network). More specifically, the present invention relates to a billing system and method for usage of a mobile Internet service employing a WLAN.

(b) Description of the Related Art

In general, a WLAN employs RF (radio frequencies) or light to wirelessly transmit and receive data between computers or between a computer and a communication device. The WLAN has been greatly developed following the fast development of Internet services and wireless communication techniques, and it is mainly installed in places where it is difficult to build a cable network such as in large offices and product delivery centers or in the case of inter-building network access, and easy maintenance of the WLAN quickly increases its usage.

In the case of accessing the Internet using the WLAN, a user terminal is connected to a cable network (e.g., a hub and a router) through a wireless access point, and it is then connected to a server of a network service provider through the Internet. After this, the user terminal receives various Internet services from the server of the network service provider.

A billing process for the Internet service usage using the WLAN, an ADSL (asymmetric digital subscriber line), a leased line, or a cable modem adopts a flat rate system for a registered user to pay a predetermined price according to a time period such as a month, a day, or an hour.

However, the flat rate system is unfair for users who do not frequently access desired Internet services or who randomly access the same.

A specific billing system for charging depending on a service usage amount by the user in the case of a modem access on a telephone network or in the mobile Internet service employing a cellular phone is also used, but high-speed Internet services using ADSL or cable have not yet adopted the specific billing system.

The reasons for this are as follows. First, it is difficult to realize a billing measuring agent. That is, since the conventional specific billing system uses a header region of an Internet layer (e.g., an IP level) of a packet or uses its higher region, it is difficult to implement a billing measuring agent for using an MAC (media access controller) address provided on top of the packet, and since it also requires many resources to use the specific billing system, heavy loads are applied to the system.

Second, billing management may be applied to cases of registering telephone numbers or devices and using them in the like manner of the telephone and cellular phones, but it is practically impossible to register devices (e.g., LAN cards) of general Internet users and bill them. That is, since most Internet users use site authentication on the ID and password basis, it is impossible to directly bill predetermined numbers, differing from the telephone and cellular phone case.

### SUMMARY OF THE INVENTION

It is an object of the present invention to provide a billing system and method for billing a wireless Internet user according to service usage amounts to reasonably perform a billing process depending on the service usage.

It is another object of the present invention to conveniently measure the user's wireless Internet service usage amounts.

In one aspect of the present invention, a billing system connected to a wireless access point for wireless network access, for charging for a service provided to a user terminal connected to the network, comprises: a billing database for storing a charge data record (CDR) for indicating a used amount of data packets provided to the user terminal according to supply of a service to the user terminal; and a billing processor for using a usage data record (UDR) provided by the wireless access point to generate the CDR, and using the CDR to bill the user for the used service, the UDR including a data packet amount and a data packet count provided to the user terminal corresponding to a hardware address of the user terminal.

The wireless access point comprises: a data repeater for transmitting the data packet transmitted according to service supply to a user terminal; a measurer for using the hardware address of the user terminal to measure a data packet amount transmitted to the user terminal; and a record processor for generating a UDR indicating a used amount of data packets provided to the user terminal, updating the UDR on the basis of measurement information of the measurer, and providing the updated UDR to the billing system.

The wireless access point generates a user management table for recording a port number connected to the user terminal, which is matched with the hardware address of the user terminal, an authentication state of the user terminal, a data packet amount, and a data packet count provided to the user terminal.

The CDR comprises a data packet amount provided to the user terminal matched with the user terminal's hardware address and user ID, a data packet count, a data packet transmission start time, a data packet transmission end time, and a usage time during which the data packets are transmitted.

The UDR records a user ID matched with the hardware address of the user terminal, a data packet amount, and a data packet count provided to the user terminal.

The wireless access point generates a user management table for recording a port number connected to the user terminal matched with the user terminal's hardware address and the user ID, an authentication state of the user terminal, a data packet amount and a data packet count provided to the user terminal.

The CDR comprises a data packet amount and a data packet count provided to the user terminal matched with the user ID, a data packet transmission start time, a data packet transmission end time, and a usage time during which the data packets are transmitted.

The measurer of the wireless access point drives a timer when data packets are transmitted to the user terminal, and it determines that the service supply is terminated and notifies the billing system of a billing termination when no data packets are transmitted over a predetermined time frame.

The wireless access point measures a data packet used amount transmitted to the user terminal, updates the UDR according to measured results, and periodically transmits the updated UDR to the billing system.

In another aspect of the present invention, a wireless access point connected to a billing server and a service-providing server through a network, for repeating a user terminal's wireless network access, comprises: a data repeater for transmitting data packets transmitted by the service-providing server to the user terminal; a measurer for using the hardware address of the user terminal to measure the data packet used amount transmitted to the user terminal; and a record processor for generating a usage data record (UDR) for showing a used amount of the data packets provided to the user terminal, updating the UDR using measurement information of the measurer, and providing the updated UDR to the billing server.

In still another aspect of the present invention, a billing method by a system connected to a wireless access point for wireless network access for charging for a service provided to a user terminal connected to the network, comprises: (a) the wireless access point accessing the user terminal to a wireless network; (b) the wireless access point using a hardware address of the access-authenticated user terminal to measure a data packet used amount transmitted to the user terminal; and (c) the system billing each user according to a packet used amount on the basis of the data packet used amount measured by the wireless access point.

(b) comprises the wireless access point generating a usage data record (UDR) including a data packet amount and a data packet count provided to the user terminal corresponding to a hardware address of the user terminal according to measuring of a packet used amount; and (c) comprises the system using the UDR to generate a charge data record (CDR) recording a data packet amount and a data packet count provided to the user terminal in correspondence to the user terminal's hardware address and a user ID, a data packet transmission start time, a data packet transmission end time, and a usage time during which the data packets are transmitted, and using the CDR to bill each user.

(b) comprises the wireless access point generating a usage data record (UDR) including a user ID, a data packet amount and a data packet count provided to the user terminal corresponding to a hardware address of the user terminal according to measuring of a packet used amount; and (c) comprises the system using the UDR to generate a charge data record (CDR) recording a data packet amount and a data packet count provided to the user terminal in correspondence to the user terminal's hardware address, a data packet transmission start time, a data packet transmission end time, and a usage time during which the data packets are transmitted, and using the CDR to bill each user.

The hardware address of the user terminal is an address of a wireless LAN (local area network) card installed in the user terminal.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a brief schematic diagram of a wireless Internet system according to a preferred embodiment of the present invention;

FIG. 2 shows a configuration diagram of a billing system according to a preferred embodiment of the present invention;

FIG. 3 shows a brief block diagram of a user terminal of FIG. 1 according to a preferred embodiment of the present invention;

FIG. 4 shows a billing process according to a preferred embodiment of the present invention;

FIG. 5 shows a user management table according to a preferred embodiment of the present invention;

FIG. 6 shows usage data records according to a preferred embodiment of the present invention;

FIG. 7 shows billing records according to a preferred embodiment of the present invention;

FIG. 8 shows a user management table according to another preferred embodiment of the present invention;

FIG. 9 shows usage data records according to another preferred embodiment of the present invention; and

FIG. 10 shows billing records according to another preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

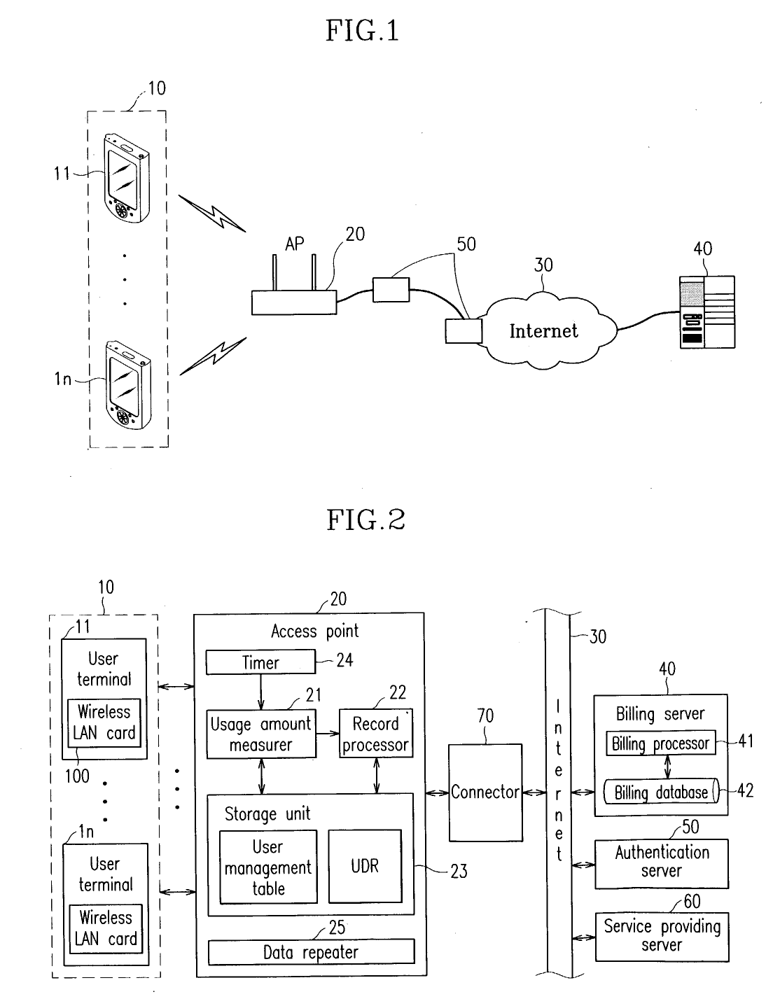

FIG. 1 shows a brief schematic diagram of a wireless Internet system according to a preferred embodiment of the present invention.

As shown, a plurality of user terminals 10 is connected to a wireless access point 20. The wireless access point 20 is connected to the Internet 30 through a connector 70 to thus be connected to a billing server 40, an authentication server 50, and a service-providing server 60.

In the preferred embodiment of the present invention, access information generated by the user terminal 10 is provided to the wireless access point 20, and the authentication server 50 uses a user ID and a password included in the access information to perform authentication, and when the data packets are transmitted from the service-providing server 60 according to the authentication, the wireless access point 20 measures a service used amount per user, that is, a packet used amount. In this instance, the wireless access point 20 uses the user terminal's hardware address included in the header of the packet to measure the packet amount or the packet count transmitted to the user terminal. The billing server 40 uses the packet used amounts per user measured by the wireless access point 20 to bill the users.

As described in the preferred embodiment, the flat sum system for billing for a predetermined time frame unit is not used, but the user is billed depending upon the user's actual service used amount, thereby enabling a more reasonable billing process, and the billing process is executed using the hardware address of the user terminal to thereby reduce loads generated when collecting billing information, and quickly and easily perform the billing process.

FIG. 2 shows detailed components of a billing system according to a preferred embodiment of the present invention.

As shown, the wireless access point 20 comprises a used amount measurer (referred to as a measurer hereinafter) 21 for measuring the user's wireless Internet service usage amounts; a record processor 22 for generating and updating UDRs (usage data records) used for measuring the usage; a storage unit 23; and a timer 24; and it further comprises a data repeater 25 for performing a data packet communication repeating function for providing the data packets provided by the service-providing server 60 to the corresponding user terminal 10.

The storage unit 23 stores user management tables for managing users, and it may temporarily store UDRs (usage data records) for showing measured information on the user's packet usage amounts.

The measurer 21 measures the data packets transmitted to the authenticated user terminal 10. In detail, the measurer 21 drives the timer 24 according to control by the billing server 40, and uses the user terminal's hardware address included in the data packets transmitted between the user terminal 10 and the service-providing server 60 to measure the user's packet usage amounts, that is, the data packet amounts and the packet count transmitted to the corresponding user terminal. The record processor 22 uses the measured information to update the UDR matched with the user terminal.

Here, the measurer 21 matches the user terminal's hardware address with a user ID to measure the user's packet usage amounts or matches the user terminal's hardware addresses to measure the user's packet usage amounts.

The billing server 40 for billing the user terminal 10 that communicates with the above-structured wireless access point 20 and receives the wireless Internet service comprises a billing processor 41 and a billing database 42.

The billing database 42 stores UDRs provided by the wireless access point 20, and CDRs (charge data records) per user generated by the billing processor 41.

The billing processor 41 controls a billing operation of the wireless access point 20, and uses the UDRs transmitted by the wireless access point 20 to generate CDRs used for billing the user terminal according to the user's actual packet usage amounts.

The authentication server 50 authenticates the wireless Internet access of the user terminal 10, and the service-providing server 60 provides the authenticated user terminal 10 with data packets corresponding to the requested service.

The connector 70 for connecting the wireless access point 20 to the Internet 30 includes a router and a hub.

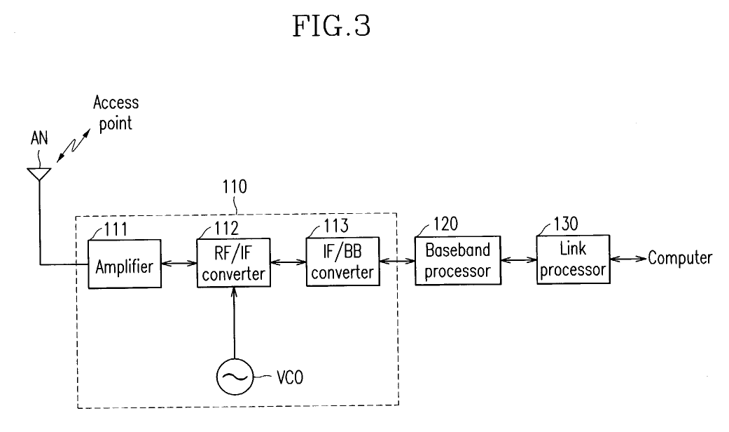

The user terminal 10 uses a wireless LAN card 100 to wirelessly access the Internet, and FIG. 3 shows a configuration of the wireless LAN card 100.

As shown, the wireless LAN card 100 comprises: an antenna AN for performing wireless data communication with the wireless access point 20; an RF unit 110 for receiving RF signals from the wireless access point 20 through the antenna AN, and transmitting RF-signal data to the wireless access point from the user terminal; a baseband processor 120 for demodulating the signals received by the RF unit 110, and modulating the data to be transmitted; and a link processor 130 for linking data between the wireless access point 20 and a processor (not illustrated) of the user terminal through a standard protocol (e.g., the IEEE 802.11b in the wireless LAN case.) In this instance, the RF unit 110 comprises: an amplifier 111 for amplifying received signals and signals to be transmitted; an RF/IF converter 112 combined with an oscillator VCO for performing signal conversion between RF signals and IF (intermediate frequency) signals; and an IF/BB converter 113 for performing signal conversion between the IF signals output by the RF/IF converter 112 and BB (baseband) signals.

Next, an operation of the billing system according to a preferred embodiment of the present invention will be described.

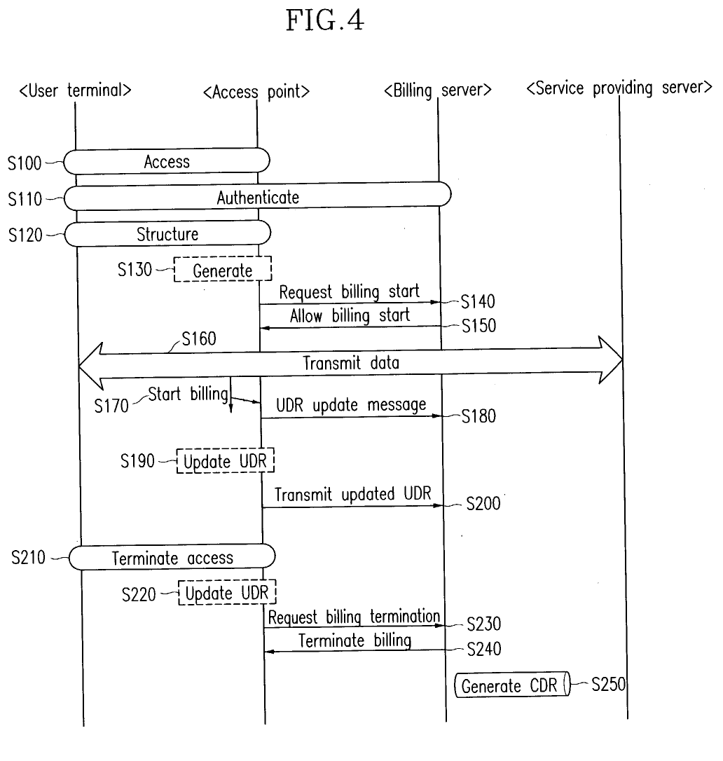

FIG. 4 shows a flowchart of a billing session process according to a preferred embodiment of the present invention.

When a user terminal 10 enters a BBS (basic service set) area where the service is provided, the user terminal's wireless LAN card 100 is connected to the wireless access point 20 in step S100, and an authentication process (e.g., the 802.1x protocol authentication) employing user information is performed so as to authenticate a user to use the service in step S110.

Here, the authentication server 50 uses information stored in the authentication server 50 to authenticate the user terminal 10 regarding whether to allow an Internet access. In detail, upon receiving a user ID and a password from the user terminal 10, the authentication server 50 allows the corresponding user terminal's access when the transmitted user ID is matched with the user ID stored in a database (not illustrated) and the transmitted password is matched with the password matched with the user ID.

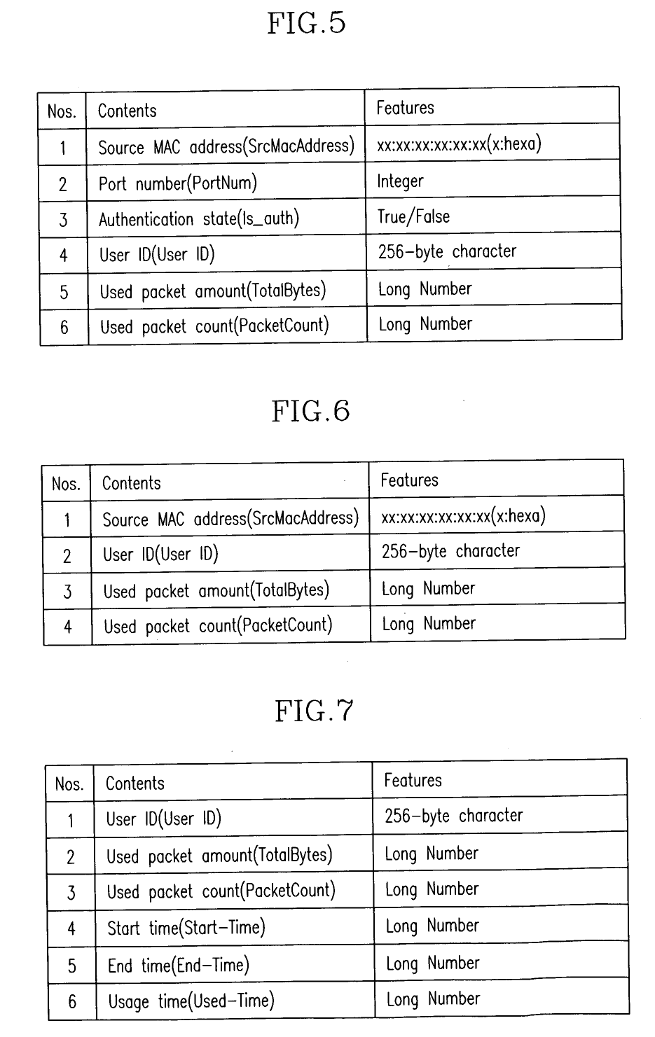

After the above-described authentication, the measurer 21 generates a user management table for managing packet usage amounts of the corresponding user terminal 10. FIG. 5 shows a structure of a user management table according to a preferred embodiment of the present invention.

As shown, the user management table records user terminal's hardware addresses (source MAC addresses,) port numbers accessed by the user terminals, authentication status, user IDs, used packet amounts that indicate service usage amounts to be subsequently received, and used packet counts. In this instance, the used packet amounts represent total data packet amounts provided to the user terminal from the service-providing server 60, and the used packet counts represent data packet counts provided to the user terminal.

The user terminal 10 is connected to the Internet 30 through the wireless access point 20 and the connector 70 according to Internet access allowance to thereby configure a wireless network in step S120, and when the authentication server 50 rejects an access authentication, the user terminal's Internet access is intercepted.

After this, when an IP is allocated to the user terminal 10 to normally set a network of the user terminal 10 according to the DHCP (dynamic host configuration protocol), which is one communication protocol for automatically allocating and managing setting information needed for performing the TCP/IP (transmission control protocol/Internet protocol) communication, the packets for the actual service may be transmitted.

As described above, when the network setting of the user terminal 10 is finished, the record processor 22 generates UDRs on the currently accessed user terminal. Here, the record processor 22 uses the user terminal's hardware address and the user ID to generate UDRs in step S130.

FIG. 6 shows an exemplified structure of the UDR according to a preferred embodiment of the present invention.

As shown, the UDR records a user terminal's hardware address (e.g., a source MAC address), a user ID, a used packet amount that is a service usage amount to be subsequently received, and a used packet count.

A user generates UDRs for measuring data provided by the service-providing server 60, and the measurer 21 transmits a billing request start message for notifying of billing session start to the billing server 40 in step S140. The billing processor 41 of the billing server 40 starts processing the billing according to the billing request start message, and transmits a billing start message that indicates billing is successfully started to the wireless access point 20 in step S150.

When the billing starts, the service-providing server 60 transmits data packets corresponding to the service requested by the user terminal 10, and the data repeater 25 of the wireless access point 20 provides the corresponding user terminal 10 with the data packets transmitted by the service-providing server 60 through the Internet 30 and the connector 70 in step S160.

The measurer 21 of the wireless access point 20 drives the timer 24 at the time of starting the service, that is, at the time of transmitting data packets, and starts billing in step S170. That is, the measurer 21 uses the user terminal's hardware address included in the data packet provided by the service-providing server 60 to determine to which user terminal the data packet is transmitted, and measures the data packet amount transmitted from the service-providing server 60 per user terminal, measures the transmitted data packet counts, and records the measured packet amount and the packet count in the UDR corresponding to the user terminal's hardware address.

During the measuring process, the record processor 22 transmits a billing information update message for updating billing information on the service performed for a predetermined time period to the billing server 40 in step S180, and records the data packet amount and the data packet count measured up to the current state in the UDR in step S190.

When a problem occurs in the system, the record processor 22 transmits periodically updated UDRs to the billing server 40 so as to prevent data loss in step S200. The billing processor 41 of the billing server 40 stores the UDRs periodically updated and transmitted by the wireless access point 20 in the billing database 42.

After this, when the service is finished according to the user's service cancel request, service time expiration, or a network device, the measurer 21 transmits a billing termination message notifying of billing session termination to the billing server 40 in steps S210 through S230, and the billing processor 41 of the billing server 40 terminates billing in response to the message, and accordingly transmits a billing termination message to the wireless access point 20 in step S240. In this instance, the measurer 21 determines that the service is terminated when no packets are transmitted during a predetermined time frame.

Here, the measurer 21 transmits the UDR storing the total data packet amounts and the total data packet counts provided to the user terminal 10 from the service-providing server 60 to the billing server 40.

The billing server 40 uses the corresponding user terminal's UDR to generate a user ID-based CDR in step S250. The CDR is also stored in the billing database 42.

FIG. 7 shows a structure of a billing record generated according to a preferred embodiment of the present invention.

As shown, the CDR records a used packet amount, a used packet count provided to the user terminal from the service-providing server, a service start time, a service end time, and a service use time.

In the above preferred embodiment, the wireless access point 20 uses the user terminal's hardware address and user ID to generate a user management table, and differing from this, the wireless access point 20 may only use the user's hardware address to generate a user management table and manage it, and it may match the user's hardware address with the user ID to generate a CDR.

In detail, when the user terminal 10 requests an Internet access, the record processor 22 of the wireless access point 20 generates a user management table corresponding to the hardware address of the user terminal.

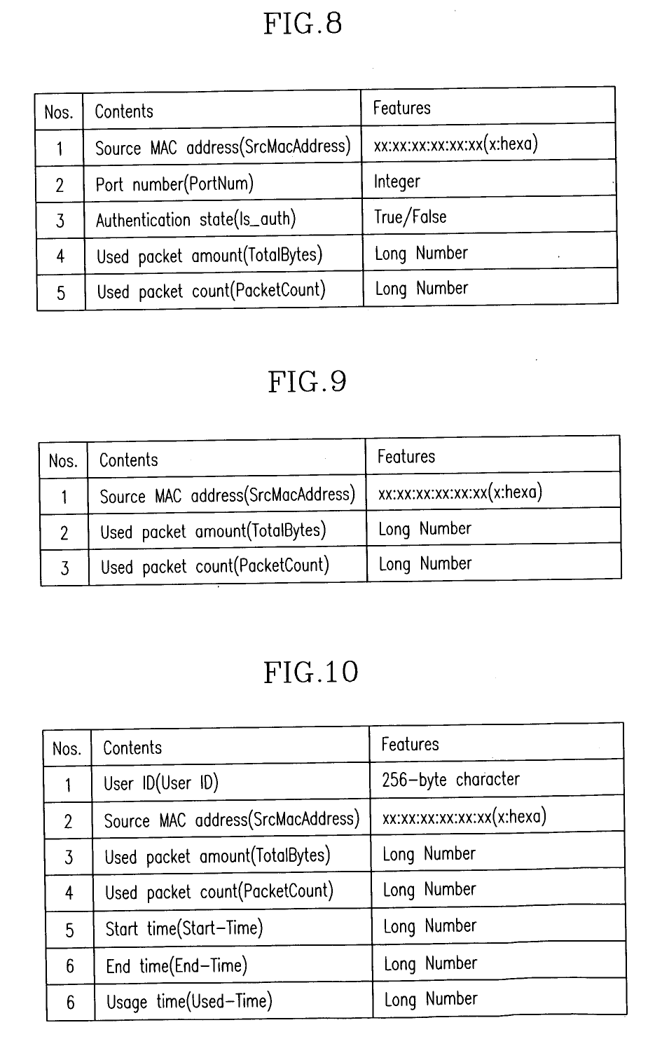

FIG. 8 shows a structure of a user management table according to another preferred embodiment of the present invention.

In this instance, as shown, the user terminal records a port number accessed by the user terminal, an authentication state, a used packet amount and a used packet count to be subsequently received.

Next, when the service-providing server 60 transmits data packets to the user terminal 10 according to the authentication, the measurer 21 starts billing and generates a UDR. FIG. 9 shows a structure of a UDR according to another preferred embodiment of the present invention.

In this instance, differing from the above embodiment, the UDR records a user ID, a used packet amount, and a used packet count to be subsequently received.

When the service is terminated and the billing session is terminated, the billing server 40 uses the UDR to generate a CDR, and in this instance, the billing server 40 uses the user terminal's hardware address and the user ID to generate a CDR.

FIG. 10 shows a structure of a CDR according to another preferred embodiment of the present invention.

As shown, the CDR records a user terminal's hardware address, a used packet amount, and a used packet count provided to the user terminal from the service-providing server in response to a user ID, a service start time, a service end time, and a service use time.

As described, in the above embodiment, an MAC address of a packet is used as an auxiliary means for collecting charges, and the actual billing is performed by matching the user ID and the MAC address.

According to the present invention, since the user is billed depending on the actually service usage amount, a more reasonable billing process may be provided between the user and a service provider.

Also, since the user is billed by using the hardware address provided on the initial portion of the packet transmitted from the user terminal, more effective billing may be performed using a simpler and cheaper device.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A billing system connected to a wireless access point for wireless network access, for charging for a service provided to a user terminal connected to the network, comprising:
a billing database for storing a charge data record (CDR) for indicating a used amount of data packets provided to the user terminal according to supply of a service to the user terminal; and
a billing processor for using a usage data record (UDR) provided by the wireless access point to generate the CDR, and using the CDR to bill the user for the used service, the UDR including a data packet amount and a data packet count provided to the user terminal corresponding to a hardware address of the user terminal.

2. The billing system of claim 1, wherein the wireless access point comprises:
a data repeater for transmitting the data packet transmitted according to service supplied to a user terminal;
a measurer for using the hardware address of the user terminal to measure a data packet amount transmitted to the user terminal; and
a record processor for generating a UDR indicating a used amount of data packets provided to the user terminal, updating the UDR on the basis of measurement information of the measurer, and providing the updated UDR to the billing system.

3. The billing system of claim 1, wherein the wireless access point generates a user management table for recording a port number connected to the user terminal, which is matched with the hardware address of the user terminal, an authentication state of the user terminal, a data packet amount, and a data packet count provided to the user terminal.

4. The billing system of claim 1, wherein the CDR comprises a data packet amount provided to the user terminal matched with the user terminal's hardware address and user ID, a data packet count, a data packet transmission start time, a data packet transmission end time, and a usage time during which the data packets are transmitted.

5. The billing system of claim 1, wherein the UDR records a user ID matched with the hardware address of the user terminal, a data packet amount, and a data packet count provided to the user terminal.

6. The billing system of claim 5, wherein the wireless access point generates a user management table for recording a port number connected to the user terminal matched with the user terminal's hardware address and the user ID, an authentication state of the user terminal, a data packet amount, and a data packet count provided to the user terminal.

7. The billing system of claim 5, wherein the CDR comprises a data packet amount and a data packet count provided to the user terminal matched with the user ID, a data packet transmission start time, a data packet transmission end time, and a usage time during which the data packets are transmitted.

8. The billing system of claim 1, wherein the measurer of the wireless access point drives a timer when data packets are transmitted to the user terminal, said wireless access point operating to determine that the service supplied is terminated when no data packets are transmitted over a predetermined time frame and to notify the billing system of a billing termination.

9. The billing system of claim 1, wherein the wireless access point measures a data packet usage amount transmitted to the user terminal, updates the UDR according to measured results, and periodically transmits the updated UDR to the billing system.

10. The billing system of claim 1, wherein the hardware address of the user terminal is an address of a wireless LAN (local area network) card installed in the user terminal.

11. A wireless access point connected to a billing server and a service-providing server through a network, for repeating a user terminal's wireless network access, comprising:
a data repeater for transmitting data packets transmitted by the service-providing server to the user terminal;
a measurer for using the hardware address of the user terminal to measure the data packet usage amount transmitted to the user terminal; and
a record processor for generating a usage data record (UDR) for showing a used amount of the data packets provided to the user terminal, updating the UDR using measurement information of the measurer, and providing the updated UDR to the billing server.

12. The wireless access point of claim 11, wherein the wireless access point generates a user management table for recording a port number connected to the user terminal, which is matched with the hardware address of the user terminal, an authentication state of the user terminal, a data packet amount, and a data packet count provided to the user terminal.

13. The wireless access point of claim 11, wherein the UDR records a user ID matched with the hardware address of the user terminal, a data packet amount, and a data packet count provided to the user terminal.

14. The wireless access point of claim 11, wherein the hardware address of the user terminal is an address of a wireless LAN (local area network) card installed in the user terminal.

15. A billing method by a system connected to a wireless access point for wireless network access for charging for a service provided to a user terminal connected to the network, comprising:
(a) the wireless access point accessing the user terminal to a wireless network;
(b) the wireless access point using a hardware address of the access-authenticated user terminal to measure a data packet usage amount transmitted to the user terminal; and
(c) the system billing each user according to a packet usage amount on the basis of the data packet usage amount measured by the wireless access point.

16. The billing method of claim 15, wherein (b) comprises the wireless access point generating a usage data record (UDR) including a data packet amount and a data packet count provided to the user terminal corresponding to a hardware address of the user terminal according to measuring of a packet usage amount; and (c) comprises the system using the UDR to generate a charge data record (CDR) recording a data packet amount and a data packet count provided to the user terminal in correspondence to the user terminal's hardware address and a user ID, a data packet transmission start time, a data packet transmission end time, and a usage time during which the data packets are transmitted, and using the CDR to bill each user.

17. The billing method of claim 15, wherein (b) comprises the wireless access point generating a usage data record (UDR) including a user ID, a data packet amount, and a data packet count provided to the user terminal corresponding to a hardware address of the user terminal according to measuring of a packet usage amount; and (c) comprises: the system using the UDR to generate a charge data record (CDR) recording a data packet amount and a data packet count provided to the user terminal in correspondence to the user terminal's hardware address, a data packet transmission start time, a data packet transmission end time, and a usage time during which the data packets are transmitted, and using the CDR to bill each user.

18. The billing method of claim 15, wherein the hardware address of the user terminal is an address of a wireless LAN (local area network) card installed in the user terminal.

19. A billing system comprising:
a) a wireless access point providing wireless network access to a user terminal connected to a network and having a usage data record corresponding to the user terminal;
b) a billing processor using the usage data record provided by the wireless access point to bill the user for wireless network usage, the usage data record including a data packet amount and a data packet count provided to the user terminal corresponding to a hardware address of the user terminal.

20. A wireless access point for connecting to a billing server and a service-providing server through a network, providing a user terminal's wireless network access, comprising:
a data repeater for transmitting data packets transmitted by the service-providing server to the user terminal;
a measurer for using the hardware address of the user terminal to measure the data packet usage amount transmitted to the user terminal; and
a record processor for generating a usage data record (UDR) for storing a used amount of the data packets provided to the user terminal, updating the UDR using measurement information of the measurer, and providing the updated UDR to the billing server.

21. A billing method for charging for a service provided to a user terminal wirelessly connected to a network, comprising:
a) an access-authenticated user terminal wirelessly accessing the network using a wireless access point;
b) the wireless access point using a hardware address of the access-authenticated user terminal to measure a data packet usage amount transmitted to the user terminal; and
c) billing each user according to a packet usage amount on the basis of the data packet usage amount measured by the wireless access point.

22. A billing method comprising:
a) providing wireless network access to a user terminal connected to the network and having a usage data record corresponding to the user terminal;
b) using the usage data record provided by the wireless access point to bill the user for wireless network usage, the usage data record including a data packet amount and a data packet count provided to the user terminal corresponding to a hardware address of the user terminal.
